(19) United States
(12) Patent Application Publication
(10) Pub. No.: US 2006/0168741 A1
(43) Pub. Date: Aug. 3, 2006

(54) Process for the production of Bis-DMTD

(76) Inventors: Wilhelm Laufer, Mannheim (DE); Michael Wuehr, Hirschberg (DE); Patrick Galda, Karlsruhe (DE); Walter Lemmin, Lampertheim (DE)

Correspondence Address: LANXESS CORPORATION, 111 RIDC PARK WEST DRIVE, PITTSBURGH, PA, 15275-1112, US

(21) Appl. No.: 11/324,867

(22) Filed: Jan. 4, 2006

(30) Foreign Application Priority Data
Jan. 31, 2005 (DE) 10 2005 004472.7

(51) Int. Cl. A61Q 5/10

(52) U.S. Cl. 8/411

(57) ABSTRACT

The present invention concerns a new improved process for the production of Bis-DMTD (5,5′-dithiobis-(1,3,4-thiadiazole-2-thiol)).

The invention concerns a new process for the production of Bis-DMTD (5,5′-dithiobis-(1,3,4-thiadiazole-2-thiol)) of the formula (1) 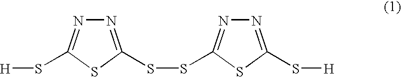
(in the following mainly mentioned as only Bis-DMTD).

Bis-DMTD is known as a compound which is particularly used for lubricants in order to give the lubricants extreme pressure characteristics (compare in particular EP 0 122 317).

As a process for the production of Bis-DMTD, EP 0 122 317 mentions the oxidation process of 2,5-dimercapto-1,3,4-thiadiazole (DMTD) with iodine, as is also disclosed in U.S. Pat. No. 3,161,575. This process is, however, extremely disadvantageous as it requires the use of the highly corrosive iodine. Also, it is already mentioned in said U.S. Pat. No. 3,161,575 that this production method leads to the creation of further products, which concern the polymeric oxidation products of formula 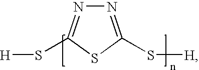
wherein n>1. These polymeric oxidation products must be extensively removed as their presence disadvantageously influences the further uses of the desired dimer.

This known production process goes back to E. Ziegele, J. Prakt. Chem. 16, 40 (1899), who describes the production of the dimer by oxidation of the thiadiazole-2,5-dithiol in alcohol solutions with iodine or iron(III)-chloride. Also, the use of iron(III)-chloride is disadvantageous, however, because of the presence of halogenides. Furthermore, an insoluble residue results, which probably also concerns the polymeric oxidation product shown above.

S. M. Losanitch in Soc. 121, 1542 (1921) carries out the oxidation in an alcohol solution of DMTD with an excess of iodine. He obtains a compound which, according to his information, is not identical with the polymeric compound found by Ziegele and which has the composition C₄H₄N₄S₇.

It is known from EP 0 135 152 that the reaction of 2,5-di-mercapto-1,3,4-thiadiazole with hydrogen peroxide leads to the formation of a dimeric product of the following formula (bis-[2,5-dithio-1,3,4-thiadiazole]):

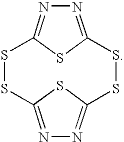

The oxidation of DMTD with H₂O₂ has so far only been described in the presence of a further reaction partner. Thus, processes have been described in U.S. Pat. Nos. 3,087,932 and 3,663,561, by which oil-soluble derivatives of DMTD are achieved by the conversion of DMTD, hydrogen peroxide and mercaptans. These products are, however, not uniform and partially require additional reworking. A process for the production of similar compounds using chlorine is known from U.S. Pat. No. 3,821,236.

Polymers of 1,2,4-thiadazole are known from U.S. Pat. No. 4,107,059, for example.

The conversion of DMTD with hydrogen peroxide leads, according to U.S. Pat. No. 4,246,126, to a material which is not characterized more specifically.

In U.S. Pat. No. 5,563,240 the conversion of DMTD with dichlorosulphanes in the presence of sodium hydroxide is described.

A process for the production of Bis-DMTD which is satisfactory for industrial standards is so far not available.

Therefore, the present inventors made it their business to find an industrially satisfactory process for the production of Bis-DMTD, starting with DMTD, which leads to high yields and high selectivity of the formation of Bis-DMTD. In particular, the process should advantageously do without the use of highly corrosive halogen-containing oxidation agents.

This problem can be surprisingly solved by the replacement of the protective group X in a Bis-DMTD derivative of the following formula (2) 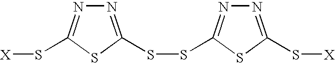
with hydrogen, preferably using a Bronstedt acid. In principle, group X is any protective group which is suitable to protect the mercapto group from further oxidation with a non-halogen-containing oxidation agent, in particular, by peroxides, under formation of a dithio group (—S—S—) (consequently polymeric by-products), and which can, for example, be transferred again to a mercapto group by acid hydrolysis. These requirements are surprisingly met, in particular, by an alkali metal such as sodium, potassium, etc. Particularly preferred in group X is sodium. Then, in particular, a salt-containing thio compound (—S⁻M⁺, whereby M is a metal) is concerned. The production of the compound of formula (2) succeeds in particular by the reaction of a monomer compound of formula (3) 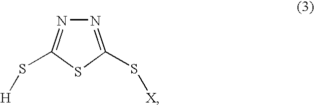
wherein X is as described above, particularly preferred by the reaction of the compound of formula (3′): 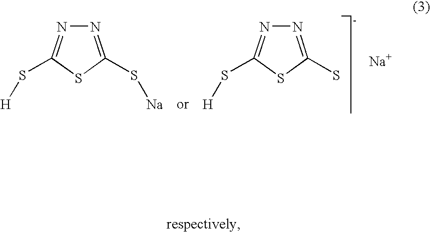
with at least one peroxide. Surprisingly, the protected mercapto group —S—X. in particular, —SNa respectively, is not subjected to oxidation and only the —SH-group is selectively oxidized under formation of a dithio group (—S—S—). Thus, it is successfully managed to keep the oxidation at the step of the dimer compound of formula (1) and to obtain the compound of formula (1) with high yields and high purity. The present invention therefore concerns, in particular, a process for the production of a compound of the compound of formula (1), which comprises the following steps:

(a) reacting an —SH-group in DMTD of formula (4): 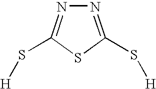
under formation of a compound of formula (3) 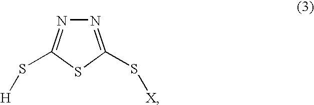
wherein X is a group which prevents the oxidation of the sulphur atom, to which it is attached, in particular, by further reaction with peroxides,

(b) subjecting the compound of formula (3) to at least one non-halogen-containing oxidation agent, in particular, a peroxide, under formation of a compound of formula (2): 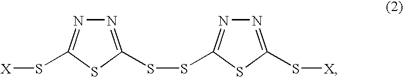
wherein X is defined as above, and

(c) conversion of the compound of formula (2) into a compound of formula (1):

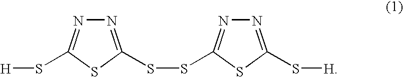

The peroxide can be any suitable peroxide compound, such as organic peroxides or inorganic peroxides. However, hydrogen peroxide is particularly preferred. Hydrogen peroxide is preferably used in the form of an approximately 30 to 40%, in particular 35% H₂O₂ solution. The reaction of the compound of formula (3) with H₂O₂ is preferably carried out with slightly raised temperatures (30 to 80, preferably 50 to 60° C.) in an aqueous solution.

The production of a compound of formula (3) works particularly well with the reaction of DMTD with equimolar amounts of a compound which introduces the protective group. The compound with which the protective group is introduced is, in particular, an inorganic base, preferably sodium hydroxide. Insofar as the molar ratio of about 1:1 is kept, the mono-protective compound of formula (3) can be selectively obtained. The adherence to this stoichiometric ratio can be monitored on an industrial scale by simple potentiometric measurements.

The object of the invention is therefore also the compounds of formula (2) 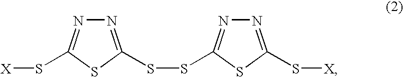
and formula (3) 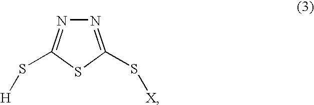
wherein X in each case is as described above. X is preferably an alkali metal, particularly preferred is sodium.

The production of the compound of formula (3) is preferably carried out in water or a mixture of water with alcohols, such as, e.g. methyl alcohol or ethyl alcohol.

As an alkali metal salt is preferred for the protected compound of formula (3), this compound is soluble in water and aqueous solutions, respectively and the resulting clear solution can subsequently be subjected to oxidation, preferably with a peroxide.

The present invention is further illustrated by the following example:

### EXAMPLE

65.1 g (0.5 mol) DMTD are stirred into 400 ml water over a period of 30 minutes. Subsequently, there follows the measured addition of 80.0 g of an aqueous 25 wt-% sodium hydroxide solution (equivalent to 0.5 mol NaOH) under water cooling. Thereafter it is stirred for about another hour at room temperature. The formation of the mono-salt is controlled by the determination of the acid number. If necessary, further DMTD can still be added. An aqueous 35 wt.-% hydrogen peroxide solution (12.1 g) is added to the obtained solution during about 30 minutes. It is then stirred for a further half hour. The addition of hydrochloric acid solution (0.32 wt-%) (28.5 g) can commence immediately after the addition of hydrogen peroxide. The desired product Bis-DMTD precipitates as a practically pure yellow powder. It is filtered off and washed until the filtrate reacts neutrally and is then dried in a rotary evaporator.

The yield was >95% of the theoretic yield, and the spectroscopic characteristics correspond to those of the known product.

1. Process for the production of Bis-DMTD (5,5-dithio-bis-(1,3,4-thiadiazole-2-thiol)) of formula (1) 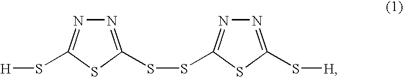
which comprises step (c):
conversion of the group X in a compound of formula (2) 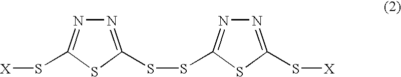
wherein X represents a protective group, into a hydrogen atom under formation of Bis-DMTD of formula (1).

2. A process according to claim 1, which comprises the step:
(b) subjecting a compound of formula (3) 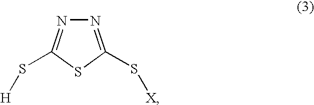
wherein X represents a protective group, to the oxidation with at least one oxidation agent under formation of the compund of formula (2) 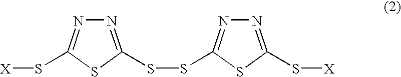
wherein X is defined as above, and
(c) conversion of the groups X in the compound of formula (2) 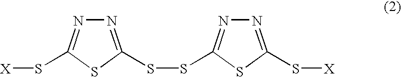
wherein X is defined as above, into hydrogen atoms under formation of Bis-DMTD of formula (1).

3. A process according to claim 2, wherein the oxidation agent does not contain halogen.

4. A process according to claim 2 or 3, wherein the oxidation agent is selected from peroxides.

5. A process according to claim 4, wherein the peroxide is selected from inorganic or organic peroxides.

6. A process according to any of the claims 2 to 5, wherein the oxidation agent is hydrogen peroxide or an aqueous solution therefrom respectively.

7. A process according to any of claims 1 to 6, which comprises the steps
(a) Inserting a protective group X into a compound of formula (4): 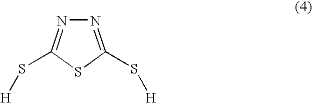
under formation of a compound of formula (3) 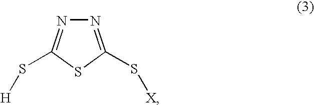
wherein X represents a protective group.
(b) subjecting a compound of formula (3) 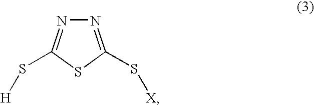
wherein X represents a protective group, to the oxidation with at least one oxidation agent under formation of the compund of formula (2) 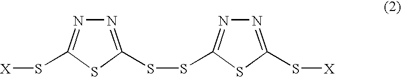
and
(c) conversion of the groups X in the compound of formula (2) 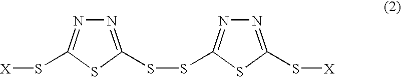
wherein X is defined as above, into hydrogen atoms under formation of Bis-DMTD of formula (1).

8. A process according to any of claims 1 to 7, wherein X is a protective group, which protects the group —S—X from oxidation with an oxidation agent, in particular, a peroxide.

9. A process according to any of claims 1 to 8, wherein X is a metal.

10. A process according to any of claims 1 to 9, wherein X is an alkali metal.

11. A process according to any of claims 1 to 10, wherein X is sodium.

12. A process according to any of claims 1 to 11, wherein in step (c) the conversion of protective group X into the hydrogen atom is carried out by hydrolysis.

13. A process according to any of claims 1 to 12, wherein in step (c) the conversion of protective group X into the hydrogen atom is carried out by the treatment with a mineral acid.

14. A compound of formula (2) 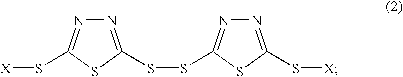
wherein X is a protective group which is suitable for protecting the sulphur atom, with which it is bound, from oxidation with an oxidation agent, in particular, a peroxide.

15. A compound of formula (3) 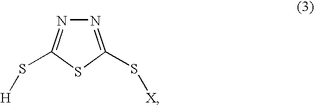
wherein X is a protective group which is suitable to protect the sulphur atom, with which it is bound, from oxidation with an oxidation agent, in particular, a peroxide.

16. Compounds according to claim 14 or 15, wherein X is a metal.

17. Compounds according to any of claims 14 to 16, wherein X is an alkali metal.

18. Compounds according to any of claims 14 to 17, wherein X is sodium.

19. Use of the compounds of formulas (2) or (3) for the production of Bis-DMTD (5,5′-dithobis-(1,3,4-thiadiazole-2-thiol)) of formula (1) [chemical structure]
